(19) United States
(12) Patent Application Publication
(10) Pub. No.: US 2015/0186790 A1
(43) Pub. Date: Jul. 2, 2015

(54) Systems and Methods for Automatic Understanding of Consumer Evaluations of Product Attributes from Consumer-Generated Reviews

(71) Applicant: Soshoma Inc., San Francisco, CA (US)

(72) Inventors: Patrick Ehlen, San Francisco, CA (US); Bart Peintner, Palo Alto, CA (US); Gianmauro Calafiore, San Francisco, CA (US)

(21) Appl. No.: 14/587,946

(22) Filed: Dec. 31, 2014

Related U.S. Application Data
(60) Provisional application No. 61/922,786, filed on Dec. 31, 2013.

(51) Int. Cl. G06N 7/00; G06F 17/30

(52) U.S. Cl. CPC G06N 7/005; G06F 17/3053

(57) ABSTRACT

Consumer-generated product reviews are a mainstay of electronic commerce and a key factor in the consumer decision process. A shopper's typical online purchase decision can involve tedious reading of multiple reviews written by previous purchasers in order to find and compare products for purchase. Disclosed herein is an automated system, and associated methods, that identifies the product attributes discussed in consumer reviews and summarizes consumer sentiment for each attribute for each product thus, offering immense value to consumers and retailers alike.

### CROSS-REFERENCE TO RELATED APPLICATIONS

This application claims the benefit of priority of U.S. Provisional Patent Application Ser. No. 61/922,786, filed on Dec. 31, 2013, the contents of which are hereby incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not Applicable

### BACKGROUND OF THE INVENTION

Consumer-generated product reviews are a mainstay of electronic commerce and a key factor in the consumer decision process. A typical online purchase decision can involve extensive reading of reviews written by consumers who purchased a product, determining what the salient attributes are for a product category, assessing the pros and cons of each product based on those attributes, and, finally, comparing products within a category through evaluations of each attribute. An automated system that identifies the product attributes discussed in consumer reviews and summarizes consumer sentiment for each attribute for each product thus offers immense value to consumers and retailers alike.

Automated tools for summarizing product reviews are known in the art, for example as described by Wang and Yaman in U.S. patent application Ser. No. 12/346,903 entitled “Product or Service Review Summarization Using Attributes.” However, precision and utility in summarizing product reviews has not been attained using the prior art tools. This is because significant technical challenges exist for summarizing reviews beyond the standard challenges of understanding natural language. Problematic issues include:
(1) Reviewers use many different ways of writing about the same attributes of a product (e.g., “setup,” “set-up,” “set up,” “installation,” “configuration,” etc.).
(2) Multiple attributes are often referred to in the same sentence, often in complex ways.
(3) Many sentences in reviews do not refer to any attributes of the product.
(4) Attributes that reviewers find salient are often different from “standard” attributes that can be found in a more structured format.
(5) Reviewers often use poor grammar and punctuation.

Accordingly, there is a need in the art for sophisticated tools for the automated analysis and summarization of reviews. Specifically, there is a need for tools that overcome the technical challenges of precisely summarizing relevant product attributes from imprecise and disparately worded reviews.

### BRIEF DESCRIPTION OF THE DRAWINGS

FIG. 1. FIG. 1. Depicts a parse tree of an exemplary sentence.

FIG. 2. FIG. 2. depicts a displayed product summary for a specific television set, wherein the various product attributes and scores are displayed.

FIG. 3. FIG. 3 depicts a displayed product comparison summary for a group of television sets, where various product attributes and the score for each product is displayed.

### DETAILED DESCRIPTION OF THE INVENTION

Disclosed herein are a variety of systems, methods, computer programs, and other embodiments directed to the automated summarization of product reviews. It will be understood by one of skill in the art that the inventions described herein encompass overlapping subject matter comprising systems, methods, computer program products, and hardware directed thereto. It will be understood by one of skill in the art that the invention is practiced in any computing environment, broadly encompassing any type of computer, computer network, or combinations thereof and that practice of the invention is not limited to any single configuration of computers, operating systems, or programming languages.

In one aspect, the inventions described herein comprise systems, wherein specific processes are carried out using a combination of hardware elements and non-transitory computer-readable storage medium having computer-readable program instructions stored therein, i.e. software. In another aspect, the inventions described herein comprise specified methods which are carried out in a computing environment. In another aspect, the inventions described herein comprise memory means which store the specific computer-readable program instructions, i.e. software, which enables practice of the various methods and steps described herein.

In some embodiments, the invention comprises entirely novel solution spaces for addressing a problem. In other embodiments, the inventions comprise improvements to the prior art, the improvement being the substitution or addition of one or more novel elements or processes which enhance the prior art solutions.

As used herein, “product” will refer to a product, service, or any other thing, tangible or intangible (e.g. media) which can be the subject of multiple subjective reviews by different consumers of the product.

As used herein, “review” or “product review” will refer to a written or otherwise recorded product description, critique, appraisal, or evaluation created by a consumer of the product.

As used herein, “attribute” or “product attribute” will refer to an aspect of a product that is evaluated in a review, usually in a qualitative manner (e.g. battery life for a device, food quality for a restaurant, etc.).

As used herein, “attribute sentiment” will refer to the sentiment expressed by a review author about a particular attribute of a product (e.g. “long” in “the battery life was long” or “poor” in “the food quality was poor”).

As used herein, “product category” will refer to a certain product type, with multiple similar individual products belonging to the category. For example, the product category “sedans,” might include the Honda Civic, Toyota Corolla, and Ford Fiesta.

As used herein, “consumer” or “reviewer” will refer to a person that has written a review.

As used herein, “shopper” will refer to a person that is seeking to compare products, for example using the systems and methods of the invention.

Process Overview. In this section, one exemplary implementation of the invention is described in a summary fashion in order to illustrate the overall processes of the invention. Preliminary steps include the generation of an attribute pool specific to the product category in question and the generation of attribute models.

Attribute discovery. A pool of product reviews directed to products from a particular product category is analyzed to determine the attributes upon which consumers judge a product and to determine the wording(s) used by reviewers when describing/evaluating each attribute.

Attribute Model Generation. Reviews are analyzed to determine the frequency with which certain words or phrases are associated with a particular attribute. This allows the construction of various mathematical “attribute models” which, when applied to any given sentence or phrase, can quantify the likelihood that the sentence is about a specific attribute. In sum, attribute models provide a means of identifying sentences within a review that concern a specific attribute.

Once a pool of relevant attributes has been identified and attribute models are generated, a pool of reviews pertaining to products within a product category can be analyzed to extract and describe consumers' evaluations of the products' various attributes. The analysis results are then presented to a shopper. The simplified review analysis process is as follows:

Step 1. Attribute References are Harvested. For each product within a product category, reviews are analyzed to determine which attributes have been mentioned in the pool of reviews. Language directed to a specific attribute is detected by segmenting reviews into individual segments (e.g., sentences or phrase “snippets”) and analyzing each segment using the attribute models to determine what attribute or attributes the segment addresses, if any. Those segments found to be about a specific attribute are subsequently analyzed for sentiment.

Step 2. Value Extraction and Sentiment Analysis. When a sentence is determined to refer to a particular attribute, the sentiment expressed about that attribute must be determined. Value extraction and sentiment analysis is applied to those sentences directed to a specific attribute, to determine the opinion of the review author regarding that particular attribute. A score is assigned to that attribute based on the outcome of sentiment analysis of all the sentences relevant to that attribute in the review pool.

Step 3. Summary data presentation. In the final step, the summarized and aggregated opinions pertaining to each attribute for each product are presented to the shopper. Various novel presentation formats are provided herein, including relativistic and weighted scores that help shoppers clearly see the differences among attributes that would be obscured by simple summarizing methodologies.

Each of the steps outlined above is composed of novel processes and methodologies, and will be described in more detail below.

Attribute Discovery. Attribute discovery may be carried out by various means, none of which is mutually exclusive, such that one or more attribute discovery means may be utilized to create a list of attributes relevant to a product category.

In one embodiment, the attribute list is produced manually by inputting attributes, including alternate wordings for attributes, as known to users, manufacturers, or experts in the field of the product category.

In another embodiment, attributes inventories are obtained automatically from structured public information sources about the product. Such sources might include websites that offer reviews or ratings of consumer products, or e-commerce sites that provide attributes as a means of searching for products.

In another embodiment, product attributes are discovered automatically from the product reviews themselves, using a variety of text processing techniques. There are generally two steps to automated attribute discovery: (1) discover the words and phrases that reviewers use to describe the product when writing a review (e.g., “battery life” or “speed” or “accuracy”); and (2) learn the differing wording and phrases that reviewers use to describe the same concept and group them into a single model of the concept (e.g., “set up” or “setup” or “installation” or “configuration” are all included in a single attribute called “installation”).

One method to discover the words and phrases reviewers use to describe a product can be summarized as follows:

Step One: For a product category (e.g., “LED televisions”), a pool of reviews pertaining to different products within that product category is amassed. An automated language processing tool, as known in the art, such as a sentence segmenter is used to divide each review into a set of review sentences (S) that describe a product. As used herein, “sentences” may refer to complete sentences, segments of sentences, snippets, or other strings of words.

Step Two: For each sentence in set S, part-of-speech (POS) tagging is performed and the sentences are tokenized into a set of POS-tagged tokens (T^{S}). To facilitate clean analysis in subsequent steps, the tokens may optionally be preprocessed by lexicalizing some words into common atomic, non-compositional combinations or idiomatic phrases (e.g., “one trick pony” is lexicalized as “one_trick_pony” or “on the other hand” is lexicalized as “on_the_other_hand”). Compound nouns referring to a unitary thing or concept can also be identified by looking for frequently-occurring, sequential noun POS tags in this step, and combining them into single tokens, for example “toner cartridge.”

Step Three: Beyond any lexicalization that may be performed in Step Two, optionally, collocation analysis can be performed to identify multiple word expressions (MWEs) that are common in S and which should be treated as single unitary words. Collocations can be identified in various ways. For example, the set or product reviews S and a control set of non-product review writings can be analyzed using tools known in the art to identify MWE's unique to S. For example, in one embodiment, all unigrams, bigrams, and trigrams in S can be quantified. For bigrams and trigrams that exceed a predetermined frequency threshold, a collocation value can be calculated using known tools such as pointwise mutual information, symmetric conditional probability, or term-frequency/inverse document frequency to determine likelihood of dependency between the first and second words (for bigrams) or between the first and concatenated second and third words (for trigrams). Those bigrams and trigrams that either (a) exceed a predetermined frequency threshold, or (b) fall beneath a predetermined count of total MWEs that will be lexicalized are combined via lexicalization.

Step Four: Using tokenized sentences from S, optionally with tagged and lexicalized tokens determined in steps three and four, generate a parse tree for each sentence in S. Extract from each noun phrase (NP) any noun, noun-noun, or adjective-noun combinations and add them to a set of attribute candidates. Also adjectives are extracted from all verb-adjective phrases (VP) and retained as candidate attributes.

Step Five: The frequency of occurrence for all pairs of attribute candidates and associated sentiments is determined. Those attribute-sentiment pairs that exceed a predetermined threshold are retained. Generally, the frequency distribution of identified candidate attributes and associated sentiments will follow an exponential distribution, with a few candidates appearing multiple times while others are present a few or just one time. One of skill in the art can readily determine the appropriate threshold which retains the higher frequency and more likely attribute candidates while excluding non-applicable or obscure terms.

Step Six. Merging. Attribute candidates comprising alternative words or wordings for the same attribute concept are merged into a single attribute concept to create coherent clusters.

Attribute Model Creation. Each attribute may be associated with one or more attribute models. The purpose of the attribute model is to identify whether or not a sentence from a consumer review refers to that attribute. The attribute model is a probabilistic prediction of a sentence or sentence segment's association with a specific attribute that relies on the presence and/or proximity of frequently-associated words, grammatical patterns, or any other elements present within the sentences that correlate with the sentence addressing that attribute.

For example, in one implementation, an attribute model is created by selecting a number of sentences known to be about a specific attribute, for example “ease of installation.” A second set of sentences known to not be about the attribute are also selected. These two set of sentences are input into a classifier, as known in the art, which calculates weights for the presence and/or position of certain words and word strings and other facets of the sentence contents or structure as predictors of each attribute. For example, an attribute model could be instantiated as a set of weighted words or n-grams, represented as a regular expression, a context-free grammar, a hidden Markov model, a vector-space model, a maximum entropy model, a naive Bayes model, a shallow neural net model, a deep belief net, or a combination of these.

In one embodiment, the model identifies those words and multiple word elements which are most highly correlated with the sentence being about the attribute, and assigns each a rank, the rank being weighted by the degree of predictive power each such word or multiple word element carries. When analyzing a sentence, the output of such a model is a score which is the sum of the weighted value of those predictive words present in the sentence.

For each such analysis, the result will be, for each attribute, a model which predicts the likelihood that a sentence is about that attribute based on the presence and/or position of certain words/phrases or other elements of the sentence. For example, applying an attribute model directed to “ease of installation” to a candidate sentence, such a model would likely predict an increased probability that the sentence addressed “ease of installation” if words and phrases are present such as “install,” “set-up,” “setup,” “easy,” etc. The models will also identify natural language expressions likely affiliated with the attribute such as “was a snap,” or “easy as pie.”

Application of an attribute model to sentences or segments occurs as follows: Sentences from reviews are each individually analyzed by at least one model per attribute, resulting in a score which indicates the goodness-of-fit for that sentence to the attribute. Based on a selected threshold, which is readily determined by one of skill in the art, those sentences with a higher probability of addressing an attribute can be retained for subsequent sentiment analysis and summarization.

In one embodiment, two or more attribute models are utilized to analyze each sentence in a pool of reviews. Where multiple attribute models are utilized, the resulting scores can be summed, or weighted and then summed when certain models are considered more probative than others. Advantageously, analyzing the sentences by multiple models results in a richer analysis which more likely harvests sentences concerning an attribute because the strengths of each model are capitalized on while the weakness of each model are compensated by the use of alternative methods.

Another advantage of this approach, in contrast with prior art methods, is the ability to identify multiple attribute sentiments in a single sentence. For example, the sentence “I liked the screen size but the battery life was short,” contains opposite sentiments about two different attributes. Using the prior art approach, sentences are typically categorized as being about a single attribute, which in this instance would miss half the information. By running each sentence against models for multiple attributes, a sentence about two or more attributes can be properly associated with each. The approach of the invention therefore overcomes a major obstacle in the automated interpretation of complex and compound sentiments found in natural language.

Merging. Once the candidate attributes have been harvested from the reviews, a merging step is performed to join separately identified words and phrases which describe the same attribute into a single attribute. For example, in reviews of a van, the words “size,” “space,” “room,” and “capacity,” would each speak to the interior space of the vehicle and each such word and compound word would be separately identified as an attribute by the automated attribute discovery means of the invention. Accordingly, each would need to be merged into a single attribute of “interior size” in order to succinctly capture all review sentiments expressed toward interior size in a single rating.

This can be accomplished by numerous means known in the art for grouping of semantically similar words/phrases. One is to use a thesaurus-like lexicon (an open source example is WordNet) to look at the semantic similarities among words, which enables grouping of the attributes into reasonable clusters. A second approach is to use a vector space model representation for semantics that will effectively plot all of the attributes and words of a document (review) into an n-dimensional vector space. Vectors that are “close” to each other in that space, due to their usage in similar contexts, will tend to form a cluster that can be thought of as a “concept” (see, for example, Widdows, Dominic (2004). Geometry and Meaning. Center for the Study of Language and Information—Lecture Notes (Book 172). Stanford, Calif., and van Rijsbergen, C. J. (2004). The Geometry of Information Retrieval. Cambridge University Press, Cambridge, UK). Exemplary vector space models include the Latent Semantic Analysis (LSA) and Latent Dirichlet Allocation (LDA), both of which have been used extensively for semantic grouping in research contexts. LDA produces “topic models” from documents, and in the case of reviews a “topic” can be thought of as a single attribute.

Value extraction and sentiment analysis. When a sentence is determined to refer to a particular attribute, the sentiment expressed about that attribute must be determined. Sentiment determination tools are well known in the art, and any such sentiment analysis tool may be utilized to analyze attribute-associated sentences to determine whether the reviewer was expressing a positive, negative, or neutral sentiment.

A major technical difficulty encountered in accomplishing this task occurs because the same sentence may discuss multiple attributes, and the sentiments expressed about those attributes may differ. For example, the phrase, “The brightness and battery life are excellent” expresses one sentiment that is distributed to two different attributes. Likewise, a phrase such as “The brightness is great but the battery life is horrible” expresses two opposite sentiments about two attributes. Thus, the sentiment for one attribute cannot be determined by scoring the sentiment polarity of each word in the sentence and then summing those scores, as this would miss the nuances of sentiment that are often expressed. Yet another difficulty is that words that may be considered positive for an attribute for one product may be regarded as negative for the same attribute for another product.

In one embodiment, value extraction and sentiment analysis can be performed by the following general process:

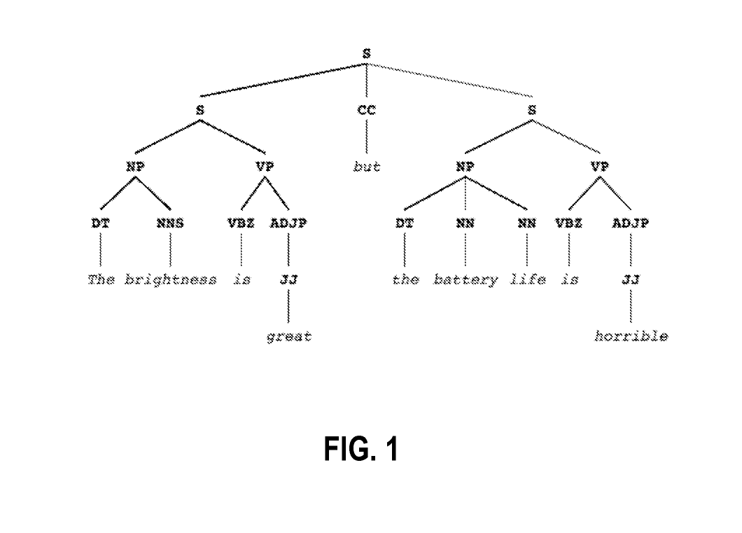

Step One: Using a natural language parser, the sentence is parsed into typed dependencies. See FIG. 1 for a sample parsing of “The brightness is great but the battery life is horrible.”

Step Two: The noun phrases relating to each attribute and the sentiment-bearing parts of the sentence associated with that noun phrase are determined through predetermined parse patterns that are typical for attribute/sentiment expressions.

Step Three: From sentiment patterns in step two, sentiment-bearing value words are extracted. For example, in FIG. 1, two sub-phrases are extracted from the exemplary sentence by splitting the sentence at the conjunction (CC), and then analyzing each phrase separately for sentiment. Sentence element labels depicted in FIG. 1 are as used in the Penn TreeBank, as known in the art, including: S=sentence; CC=coordinating conjunction; NP is noun phrase; VP is verb phrase; DT is determiner; NN is noun; NNS is nouns plural; VBZ is verb, third person singular present; JJ is adjective; and ADJP is adjective phrase. Alternatively, each noun phrase and its associated value, can be extracted e.g.

NN1: brightness

ADJ1: great

NN2: battery life

ADJ2: horrible

Step Four: For each attribute and value extracted in step three, score sentiment using an attribute- and category-specific model, where words or n-grams that indicate positive or negative valence for a product are weighted and summed to provide an overall sentiment score for the sentence or clause that discusses the attribute. Sentiment models are category specific, since the same expression for an attribute may be regarded as positive for one category while negative for another.

In one embodiment, sentiment analysis is performed with the aid of sentiment models. The sentiment models are analogous to the attribute models described previously. In short, what each sentiment model does is to determine the mathematical probability that a sentence is expressing a certain polarity (i.e. positive or negative) sentiment about an addressed attribute. Each such model is then applied to the sentences about that attribute, and those sentences which are scored above a selected threshold can be determined to be positive or negative, depending on which polarity the model detects.

In one embodiment, a sentiment model may be generated using two sets of test data comprising a set of sentences that is known to express positive sentiments about an attribute and a set of sentences which is known to express negative or neutral sentiments about an attribute. These are fed into a classifier, as known in the art, which calculates the correlation between a positive sentiment and the presence and/or position of certain words and word strings and other facets of the sentence contents or structure. For example, an attribute model could be instantiated as a set of weighted words or n-grams, represented as a regular expression, a context-free grammar, a hidden Markov model, a vector-space model, a maximum entropy model, a naive Bayes model, a shallow neural net model, a deep belief net, or a combination of these.

In one embodiment, the model identifies those words and multiple word elements which are most highly correlated with the sentence expressing the selected polarity about the attribute, and assigns each a rank, the rank being weighted by the degree of predictive power each such word or multiple word element carries. When analyzing a sentence or sentence segment for sentiment analysis, the output of such a model is a score which is the sum of the weighted value of those predictive words present in the sentence.

For each such analysis, the result will be, for each sentiment model, a tool which predicts the likelihood that a sentence about that attribute is positive, based on the presence and/or position of certain words/phrases or other elements of the sentence. For example, applying an attribute model directed to “sound quality” to a candidate sentence, such a model would likely predict an increased probability that a positive sentiment about “sound quality” was expressed if words and phrases are present such as “crystal clear,” “clean,” “crisp,” etc. The models will also identify natural language expressions likely affiliated with the attribute such as “clear as a bell,” or “static-free.”

As with attribute models, multiple sentiment models can be run against sentences directed to an attribute, with scores optionally weighted to favor preferred models. The resulting sum of scores from multiple models can be used to classify sentiment as positive or not. Non-positive sentiments can be scored as neutral or negative. Conversely, a model detecting the probability of negative sentiment can be utilized instead, or a combination of models detecting positive and negative sentiments can be utilized.

Buying Decision Trigger Sentences. User reviews often contain useful information beyond comments on attributes. Various decision-making factors are often shared in reviews, which provide useful information for shoppers. Such sentences will be referred to as “Buying decision trigger sentences.” Buying decision trigger sentences are sentences that contain information that is useful for shoppers selecting a product, but which don't comprise a simple evaluation of an attribute. Often, such sentences do not refer to any specific attribute at all and would be missed by an automated attribute mining system, but still contain information likely to be of high interest to shoppers. Exemplary buying decision triggers include sentences highly relevant to a consumer's decision to purchase a product, return a product, purchase the same product again, recommend a product, or buy an alternative a product. For example, the following sentences illustrate different types of buying decision triggers:

Decision to buy triggers: “I got this stereo because Bose has a great reputation”

Decision to return triggers: “I returned it after two weeks because it was too frustrating to deal with.”

Likelihood to purchase again: “I'll never buy another Treo.”

Likelihood to purchase an alternative product: “For my next phone, I'll probably get an iPhone.”

Identification of a feature that the product does not have but review authors express a wish that it did: “I wish the Aerostar had all-wheel drive.”

Comparative statement between two products from the same category: “The Trek is much heavier than the Gary Fisher.”

The invention effects automated discovery of buying decision triggers. Trigger sentences are identified using models similar to attribute models. Because buying decision triggers are likely to have unique phrasing and unique keywords/key phrases (e.g. “I chose,” “I returned,” “I should have gotten,” etc), they are amenable to automated discovery using specific models directed to their detection and analysis. The process for defining and implementing a buying decision trigger model is as follows:

Step One: For each product category, identify types of trigger sentences that are common in the reviews for that category. In one instantiation, this step can be done through manual identification of relevant sentences. Phrases or n-grams that are common to a trigger would be extracted and counted. Phrases or n-grams would then be scored by frequency for their relevancy to the buying decision trigger. Some models (such as indicators that a reviewer returned a product) may be similar or identical across product categories.

Step Two: Using the sentences extracted in Step One, which are known trigger sentences, build a model that will evaluate a target sentence's probability of being a buying decision trigger sentence based on the presence and/or position of certain words/phrases. As with attribute models and sentiment models, such buying decision trigger models can be implemented as weighted words or n-grams, represented as a regular expression, a context-free grammar, a hidden Markoff model, a vector-space model, a maximum entropy model, a naive Bayes model, or a shallow or deep neural net model, or a combination of these.

In one embodiment, the model identifies those words and multiple word elements which are most highly correlated with the sentence being a buying decision trigger sentence, and assigns each a rank, the rank being weighted by the degree of predictive power each such word or multiple word element carries. When analyzing a sentence, the output of such a model is a score which is the sum of the weighted value of those predictive words present in the sentence.

Step Three: For any new review, split the review into sentences and analyze each sentence with the buying trigger model to extract trigger matches and score them. As with attribute models and sentiment models, multiple buying decision trigger models can be implemented for each sentence and summed (and optionally weighted) scores can be calculated. Sentences with scores above a selected threshold, indicating a high likelihood of being a buying decision trigger sentence, are scored as such and retained.

A trigger sentence generally does not require sentiment analysis, as identification of the trigger type itself typically implies a particular sentiment. However, if the buying decision trigger sentence is potentially of dual polarity, further sentiment analysis, as described above, may be applied.

Advantageously, trigger sentences selected for display may highlight some uniqueness of a particular product, and, unlike an attribute, may be common across many reviews for a single product, but not common across all reviews in a particular category of products. Thus, a trigger sentence selector will detect sentences that mention a common theme in the reviews of one product that is not common among the reviews of other, similar products.

Attribute Summary Display. The output of the automated review analysis tools described herein, or the output from other automated review analysis systems (or a combination thereof) may be displayed in various ways to aid shoppers in comparing products within a product category.

In one embodiment, attribute scores for each product are displayed. For example they may be displayed as a number or percentage, e.g. “345 users rated picture quality as good” or “76% of users made positive comments about this product's durability.” Scores may be represented by some visual indicator of the discrete values of the score, such as a rating as number of stars or color coding. Each attribute/score combination may optionally be displayed with or linked to the sentences or phrases extracted from the review that provide evidence for or further explicated the evaluation of that attribute.

Any subset of attributes may be displayed and subsets of attributes may be ordered in any order, for example in one embodiment the most frequently discussed attributes for a product or products within a product category are displayed at the top of the list.

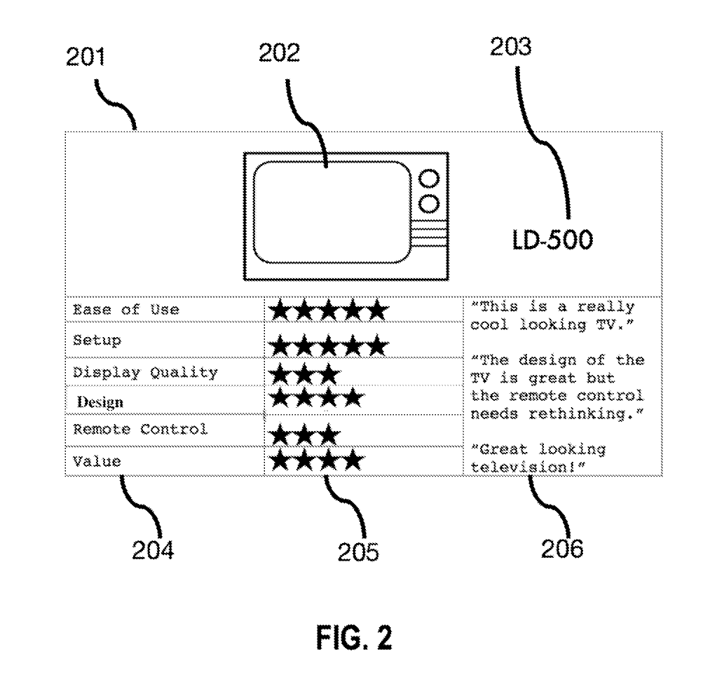

For example, FIG. 2 depicts a an exemplary displayed output (201) of a set of attributes for a television. The output depicted in FIG. 2 comprises a picture of the product (202), and the product model number (203). The output also depicts a pair of columns (204 and 205). Column 204 comprises multiple attributes of the television and Column 205 comprises the aggregated score for the television for each attribute, in this example depicted as stars that indicate the ratings for these attributes, e.g. out of five stars or out of ten stars. The exemplary display of FIG. 2 also includes a third column (206). In this column, sentences that provide evidence and explication for the television's ratings are displayed. Such sentences may describe various attributes of the product overall, or may be specific to a selected attribute, such as picture quality, for example, when such attribute is selected by the user, e.g. by clicking on or mousing over it.

Comparison of Products Using Attribute Display. Beyond displaying a single product and its attributes, multiple products from a particular category can be compared along the attribute dimensions derived from the consumer reviews text.

Comparison by attribute . . . shows an exemplary results display wherein a selection of televisions are compared side-by-side. In this display (301), attributes are listed in one column (303). Each product to be compared has its own column, for example the column 304 which corresponds to the PDB-100 television, which is depicted in an image (302). The attributes of Column 303 reflect the attributes that were selected as salient in and representative of the consumer reviews written for these particular products. For each product, a rating, for example, stars corresponding to an “out of five stars” or “out of ten stars” rating system, on that attribute for that particular product may be displayed.

Category-based attribute re-scoring. When several products from the same category are compared, the attribute scores for these products are re-scored to provide a score that is relative to the scores for the same attribute of other products in the category. For example, if all products in a category score above average on “ease of use” but one product scores exceptionally high, the values for this attribute may be scaled to reflect an average “ease of use” on all but the exceptional product, which will receive a high score.

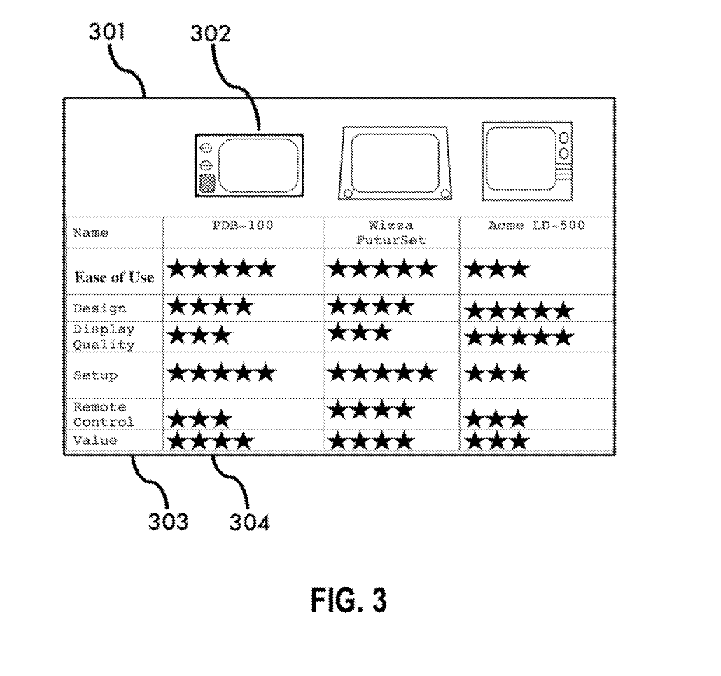

Display refinement by attribute. Such side-by-side displays may be dynamic, wherein the user's selection of a specific attribute will change the display. When the user selects one of the attributes (e.g. by clicking or mousing over the attribute in the display), products can be filtered or re-ordered by user manipulation of the attributes. If a user wishes to emphasize or de-emphasize a particular attribute, these can be manipulated at the attribute level and products will be re-selected or re-sorted according to the user's attribute manipulations. Users might manipulate the relative importance of these attributes using various means, including but not limited to HTML user interface controls such as hyperlinks, checkboxes, sliders, radio buttons, etc. In a display such as that depicted in FIG. 3, a set of products is displayed with the corresponding identified attributes, and the products are ranked by “ease of use” score, for example arranged left to right from highest ease of use score score to lowest. This interactive display can be changed by the user's selected of another attribute, for example, “display quality,” upon which selection, the displayed set of products and their ranking in the display may be changed accordingly (e.g. left to right order in the exemplar display of FIG. 3.). Optionally, when an attribute is selected, sentences from the reviews that provide evidence on that attribute for that product may also be displayed below.

Search refinement by attribute. Similar to the display refinement, a user might also define particular attributes in an initial search query, and products returned in the search would be filtered or re-ordered according to the preferences. For example, consider the query, “LED TV that with good streaming apps that is easy to set up.” Such a query could be analyzed by the attribute models and determined to relate to two attributes: Streaming apps and Configuration. A parse of this sentence could then break it into a main search term of a product category (search_term=“LED TV”), and two facets of attributes with desired values (streaming_apps=“good” and configuration=“easy”). Products from the search category would then be filtered or ranked to satisfy these attribute constraints.

Grouping products according to attribute profiles. When several products from one product group share similar scores for the same attributes, these products can be said to share the same attribute profile. For example, a set of products might share the same attribute profile and all score highly on “ease of use” and “design,” but low on “value” and “configurability,” while another attribute profile from the same category might contain products that all score low on “ease of use” and “design” but high on “value” and “configurability. These attribute profiles can thus be used to group items that are similar and may be of interest to particular consumers. Such profiles could be used to show multiple similar choices in response to a search query, or to suggest other similar products to one being viewed in response to a user action such as clicking a “more like this” hyperlink.

Personalizing search results or recommendations of products according to attribute profiles. Knowing certain configurations of attributes (or attribute profiles) may help to narrow a set of products from a category that are more appealing to some people than to others. One type of person may value the design of a product and be willing to spend extra money for that attribute, while another type of person may appreciate a good value more than they do design. If such preferences about a consumer are known, different products with these different attribute profiles can be targeted towards two different groups of consumers, offering a shopping experience that is more targeted towards the needs of different types of people.

Navigation via incremental improvements on attributes. When displaying a product and a set of scores for each attribute, the system can analyze other products in relation to the product displayed and offer attribute-based navigation links. For example, when showing a product that scores high on ease of use, high on customer service and medium on design, a link “Products with better design” could link to a set of products that score higher on design, but medium to high on the other attributes. This allows the user to step through the space of products, understand the tradeoffs, and effectively “improve” the product they are viewing in a step-wise fashion. This feature can be applied to review-based product attributes and traditional product specs.

Application to other review sources. While the above description has focused on analysis of consumer reviews, these methods could also be applied to professional reviews, as found on interne blogs or sites dedicated to providing professional reviews of products. When two or more professional reviews of the same product can be obtained from different sources, those reviews may be subjected to the same methods and tools applied to consumer reviews as described above. One difference is that such professional reviews may not require as many instances of mentioning an attribute to determining its relevance or salience, as such reviews tend to have a greater density of information-bearing sentences, with fewer sentences that might be considered as “noise.” Thus the scores of attributes that arise from professional reviews might be weighted more heavily than scores from individual consumer reviews.

Application to Other Review Domains. While the above description has focused primarily on reviews of products, these methods could also be applied to any type of merchant or service that is likely to generate consumer review activity and discussion, not limited to reviews of restaurants, leisure or service establishments, contractors, vendors, healthcare providers, educational courses or instructors, printed and multimedia publications or recordings, concerts, sports teams or activities, events, and any entity that is likely to encourage people to generate evaluative writings for the purpose of informing other potential consumers about their personal experience with that entity.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

What is claimed is:

1. In a computing environment, a method of extracting from a pool of written reviews of products within a product category the words which describe attributes pertaining to products within that category, comprising
dividing the written reviews into sentences using a sentence segmenter;
tokenizing the words within each sentence;
generating a parse tree for each sentence and extracting nouns, noun-noun combinations, and adjective-noun combinations;
quantifying the frequency of each such noun, noun-noun combination, and adjective-noun combination; and
retaining all high-frequency nouns, noun-noun combinations, and adjective-noun combinations.

2. The method of claim 1, wherein
prior to tokenization, lexicalization of non-compositional combinations or idiomatic phrases is performed.

3. The method of claim 1, wherein
prior to parsing, collocation analysis is performed which compares the frequency of multiple-word-expressions in the written product reviews to their frequency in writings that are not product reviews in order to identify those multiple-word-expressions which are uniquely frequent in the written product reviews; and
combining those multiple-word-expressions which are uniquely frequent in the written product reviews into single tokens.

4. In a computing environment, for a sentence extracted from a written product review, a method of determining the probability that the sentence is about a specific attribute, comprising
applying at least one mathematical model which correlates the presence and position of words within the sentence to the probability that the sentence is about that specific attribute.

5. The method of claim 4, wherein
the mathematical model was generated using a classifier which compares a pool of sentences known to address the specific attribute against a pool of sentences known not to address the specific attribute to identify words and phrases highly correlated with the sentence addressing the specific attribute and which assigns a weighted value to each such word or phrase based upon its predictive power, and which outputs a score comprising the sum of the weighted value of predictive words or phrases present in the sentence.

6. The method of claim 5, wherein the classifier is selected from the group consisting of:
a context-free grammar model, a hidden Markov model, a vector-space model, a maximum entropy model, a naive Bayes model, a shallow neural net model, and a deep belief net.

7. The method of claim 4, wherein
multiple mathematical models which correlate the presence and position of words within a sentence to the probability that the sentence is about that specific attribute are applied to a sentence; and
the resulting scores generated by the multiple models are summed to create a score representing the goodness-of-fit of the sentence to the specific attribute.

8. The method of claim 7, wherein
the model assigns weighted values to words and phrases and the output scores are the sum of the values of words and/or phrases present in the sentence.

9. The method of claim 8, wherein
the model output scores are binary yes/no values.

10. The method of claim 7, wherein
the model output scores are weighted such that certain of the multiple models applied to the sentence have a greater impact on the summed score.

11. In a computing environment, a method of determining the polarity of a sentiment expressed in a written sentence or sentence segment which addresses a product attribute, comprising
analyzing the sentence or sentence segment with one or more mathematical models that predict the likelihood that the sentence or sentence segment expresses a sentiment of a selected polarity.

12. The method of claim 11, wherein
the mathematical model was generated using a classifier which compares a pool of sentences known to express the sentiment of the selected polarity about the attribute against a pool of sentences known not to express the sentiment of the selected polarity about the attribute to identify words and phrases highly correlated with the sentence or sentence segment expressing the selected polarity and which assigns a weighted value to each such word or phrase based upon its predictive power, and which outputs a score comprising the sum of the weighted values of predictive words or phrases present in the sentence.

13. The method of claim 12 wherein the classifier is selected from the group consisting of:
a context-free grammar model, a hidden Markov model, a vector-space model, a maximum entropy model, a naive Bayes model, a shallow neural net model, and a deep belief net.

14. The method of claim 11, wherein
the selected polarity is selected from the group consisting of positive, negative, or neutral.

15. The method of claim 11, wherein
multiple mathematical models which that predict the likelihood that the sentence or sentence segment expresses a sentiment of a selected polarity are applied to the sentence or sentence segment; and
the resulting scores generated by the multiple models are summed to create a score representing the goodness-of-fit of the sentiment of selected polarity to the attribute in the sentence or sentence segment.

16. The method of claim 15, wherein
the model assigns weighted values to words and phrases and the output scores are the sum of the values of words and/or phrases present in the sentence.

17. The method of claim 15, wherein
the model output scores are binary yes/no values.

18. The method of claim 15, wherein
the model output scores are weighted such that certain of the multiple models applied to the sentence have a greater impact on the summed score.
